(19) United States
(12) Patent Application Publication
(10) Pub. No.: US 2012/0120300 A1
(43) Pub. Date: May 17, 2012

(54) Image Sensor with Two Transfer Gate Off Voltage Lines

(76) Inventor: Tiejun Dai, Santa Clara, CA (US)

(21) Appl. No.: 12/946,689

(22) Filed: Nov. 15, 2010

(51) Int. Cl. H04N 5/225; H01L 27/146

(52) U.S. Cl. 348/340; 250/208.1; 348/E05.024

(57) ABSTRACT

An apparatus of one aspect includes an array of pixels. Each of the pixels includes a photosensitive element and a transfer transistor coupled with the photosensitive element. Each of the transfer transistors has a transfer gate. The apparatus also includes a first transfer gate off voltage supply conductor and a second transfer gate off voltage supply conductor. A circuit is coupled with the first and second transfer gate off voltage supply conductors. The circuit is operable to couple the first transfer gate off voltage supply conductor to transfer gates of a first subset of the pixels of the array. The circuit is also operable to concurrently couple the second transfer gate off voltage supply conductor to transfer gates of a second subset of the pixels of the array.

### BACKGROUND

1. Field

This disclosure relates generally to image sensors, and in particular but not exclusively, relates to readout circuitry and readout methods for image sensors.

2. Background Information

Image sensors are prevalent. They are widely used in digital still cameras, digital video cameras, camera phones, picture phones, security cameras, medical imaging devices, optical mice, toys, computer multimedia devices, scanners, automotive image sensors, as well as other types of electronic image acquisition devices.

Image sensors are generally expected to produce images that fiducially represent the people, places, objects, or other scenery of which the images are acquired. Under most conditions, the images do fiducially represent the scenery. However, under extreme conditions, such as when imaging a bright region against a dark background, an image artifact know as banding may appear in the images.

The banding is generally undesirable. Reducing the amount of banding in images would offer certain advantages.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of an embodiment of an image sensor system.

FIG. 2 is a circuit diagram illustrating an example embodiment of pixel circuitry for two, four-transistor (4T) pixels within a pixel array or image sensor.

FIG. 3 is a circuit diagram illustrating an example embodiment of a pixel and an example embodiment of sample and hold circuitry for a pixel array or image sensor.

FIG. 4 conceptually illustrates an example of a horizontal or row banding artifact in an image.

FIG. 5 is a block diagram of an example embodiment of an image sensor having first and second transfer gate off voltage supply conductors.

FIG. 6 is a block diagram of an example embodiment of a voltage generator to generate different transfer gate off voltages for first and second transfer gate off voltage supply conductors.

FIG. 7 is a block flow diagram of an embodiment of a method of coupling first and second transfer gate off voltage supply conductors with transfer gates of first and second subsets of pixels of a pixel array.

FIG. 8 is a block flow diagram of an embodiment of a method of applying first and second transfer gate off voltages to transfer gates of first and second subsets of pixels of a pixel array.

### DETAILED DESCRIPTION

In the following description, numerous specific details, such as, for example, specific circuitry, voltages, sequences of operations, are set forth. However, it is understood that embodiments of the invention may be practiced without these specific details. In other instances, well-known circuits, structures and techniques have not been shown in detail in order not to obscure the understanding of this description.

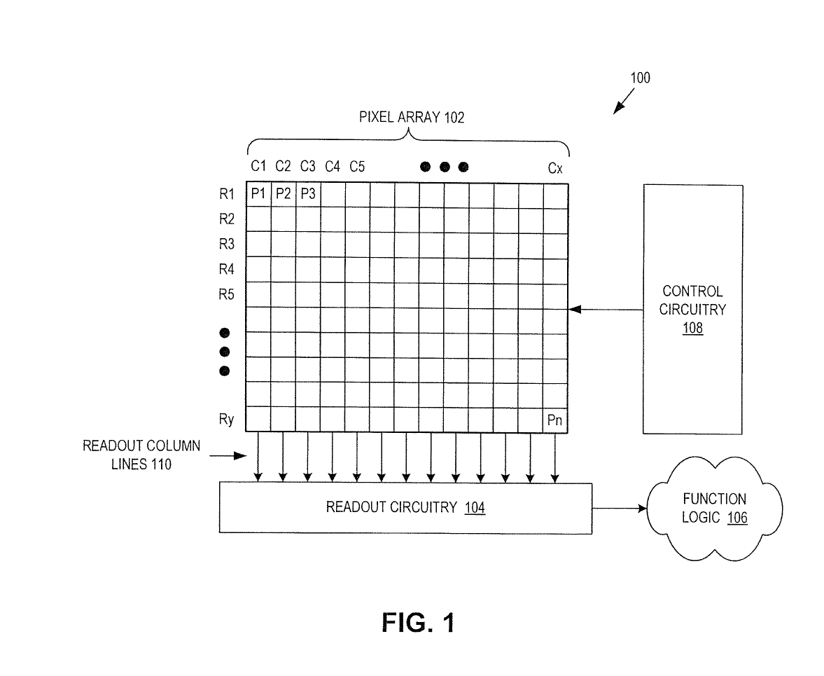

FIG. 1 is a block diagram of an embodiment of an image sensor system 100. The illustrated embodiment of the image sensor system includes a pixel array 102, readout circuitry 104, function logic 106, and control circuitry 108.

The pixel array 102 or image sensor array includes a two-dimensional array of pixels (e.g., pixels P1, P2, P3, . . . Pn). As illustrated, the pixels of the image sensor array are arranged into rows (e.g., rows R1 through Ry) and columns (e.g., column C1 through Cx). Commonly there are numerous rows and numerous columns. During image acquisition, each of the pixels may acquire image data (e.g., an image charge). In one embodiment, each pixel is a complementary metal oxide semiconductor (CMOS) pixel. The image sensor array may be implemented as either a front side illuminated image sensor array or a backside illuminated image sensor array. In one embodiment where a color image is desired, the image sensor array may include a color filter pattern, such as a Bayer pattern or mosaic of red (R), green (G), and blue (B) additive filters (e.g., RGB, RGBG or GRGB), a color filter pattern of cyan (C), magenta (M), yellow (Y), and key (K) (e.g., black) subtractive filters (e.g., CMYK), a combination of both, or another type of color filter pattern. The image sensor array may be used to acquire image data (e.g., of a person, place, or object), which can then be used to render a 2D image (e.g., of the person, place, or object).

After each pixel has acquired its image data or image charge, the image data is readout by the readout circuitry 104 and transferred to the function logic 106. In one embodiment, the readout circuitry may readout a row of image data at a time along readout column lines 110, or in another embodiment the readout circuitry may readout the image data using another approach, such as column readout, serial readout, or full parallel readout of all pixels concurrently. The readout circuitry may include amplification circuitry, analog-to-digital conversion (ADC) circuitry, gain control circuitry, or otherwise. In one aspect, the function logic may merely store the image data, or in another aspect the function logic may manipulate the image data. Various ways of manipulating the image data are known in the arts. A few representative examples include applying one or more post image effects, such as, for example, crop, rotate, remove red eye, adjust brightness, adjust contrast, etc. The function logic may be implemented in hardware (e.g., circuitry), software, firmware, or a combination thereof.

The control circuitry 108 is coupled to the pixel array to control operational characteristics of the pixel array. For example, the control circuitry may generate a shutter signal for controlling image acquisition. In one embodiment, the shutter signal is a global shutter signal for simultaneously enabling all pixels within the image sensor array to concurrently capture their respective image data during a single acquisition window or exposure period. Alternatively, the shutter signal may be a rolling shutter signal where each row, column, or other group of pixels is sequentially enabled to acquire its respective image data during consecutive acquisition windows.

In one embodiment, the image sensor array, the readout circuitry, the control circuitry, and at least some of the function logic may be monolithically integrated on a single die or substrate. Alternatively, some of this circuitry or logic may be off-die relative to the image sensor array (e.g., at least some of the function logic and/or at least some of the control circuitry may not be on the same die as the image sensor array.

In one or more embodiments, the image sensor system may be included in a digital still camera, digital video camera, camera phone, picture phone, security camera, medical imaging device, optical mouse, toy, computer multimedia device, scanner, automotive image sensor, or other electronic image acquisition device. The electronic image acquisition device may also include other components, such as, for example, a light source to emit light, one or more lenses optically coupled to focus light on the array of pixels, a shutter optically coupled to allow light to pass through the one or more lenses, a processor to process image data, and a memory to store image data.

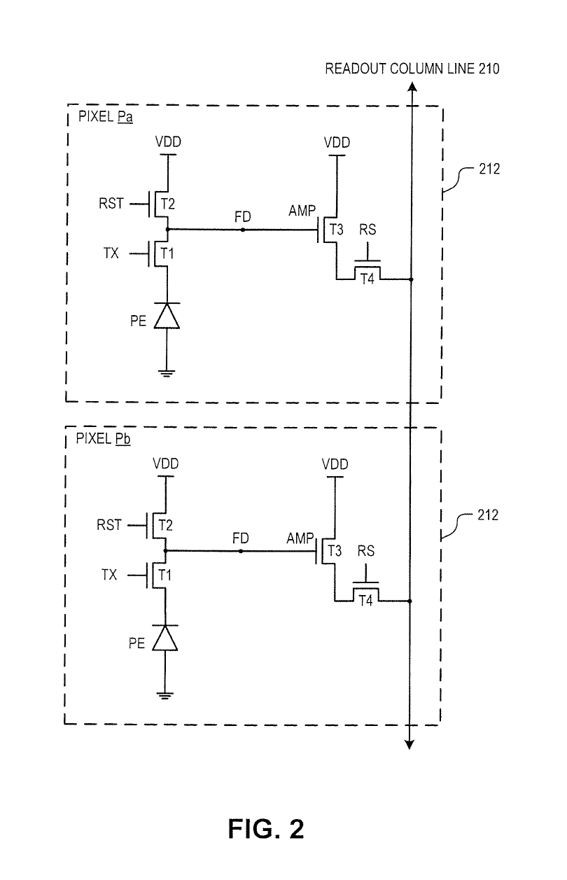

FIG. 2 is a circuit diagram illustrating an example embodiment of pixel circuitry for two four-transistor (4T) pixels Pa and Pb (collectively pixels 212) within a pixel array or image sensor array. The pixel circuitry is only one example of suitable pixel circuitry, and the scope of the invention is not limited to this particular pixel circuitry. Other pixel circuitry for other 4T pixels, as well as other pixel circuitry for pixels having transfer gates and either more or less than four transistors, including pixels in which one or more transistors are shared by two or more pixels, is also suitable. The pixel circuitry may be implemented in the pixel array 102 of FIG. 1, or an entirely different pixel array.

The pixels Pa and Pb are arranged in two rows and one column and time share a readout column line 210. The readout column line is sometimes referred to as a bit line. Each of the pixels includes a photosensitive element PE (e.g., a photodiode), a transfer transistor T1, a reset transistor T2, a source-follower or amplifier (AMP) transistor T3, a row select transistor T4, and a floating diffusion node FD. The floating diffusion node FD may represent a circuit node to receive and hold a charge.

In an example mode of operation, the reset transistor T2 may reset the pixel (e.g., discharge or charge the floating diffusion node FD and the photosensitive element PE to a preset voltage) under control of the reset signal RST applied to the reset transistor T2. The reset transistor T2 is coupled between a supply voltage VDD (e.g., a power rail) and the floating diffusion node FD. The photosensitive element PE and the floating diffusion node FD may be reset to the supply voltage VDD by temporarily asserting the reset signal RST to the reset transistor T2 and by asserting a transfer signal TX to a transfer gate of the transfer transistor T1.

The reset transistor T2 and the transfer transistor T1 may each represent a controllable switch. The transistors or switches may either be in an on state (i.e., “on”) in which they are conducting or open, or in an off state (i.e., “off”) in which they is non-conducting or closed. The transistors or switches may be controlled to be either “on” or “off” based on voltages, or other electrical signals or control signals applied to the transistors (e.g., to the gates of the transistors). For example, the assertion of the transfer signal TX may include applying a given voltage or signal to the transfer gate of the transfer transistor T1 that is operable to place the transfer transistor T1 in an “on” state.

There may be a line or wire (not shown in this illustration) to provide the voltage to the transfer gate of the transfer transistor T1.

The image accumulation window or exposure period may be commenced by de-asserting the transfer signal TX and permitting incident light to expose the photodiode or other photosensitive element PE. The de-assertion of the transfer signal TX may include applying a different voltage or other electrical signal to the transfer gate of the transfer transistor T1 that is operable to place the transfer transistor T1 in an “off' state. This may be referred to as a transfer gate off state voltage or signal. The photosensitive element PE is operable to generate a charge in response to light applied to or received by the photosensitive element PE. For example, the incident light on the photosensitive element PE may generate electrons known as photogenerated electrons. As photogenerated electrons accumulate on the photosensitive element PE, its voltage may decrease, since electrons are negative charge carriers. The amount of voltage or charge accumulated on the photosensitive element PE may be indicative of the amount/intensity of the light incident on the photosensitive element PE during the exposure period, and may represent image data.

At the end of the exposure period, the reset signal RST may be de-asserted to isolate the floating diffusion node FD. The transfer signal TX may again be asserted on the transfer gate of the transfer transistor T1 to cause the transfer transistor T1 or switch to be “on” to transfer the charge accumulated on the photosensitive element PE to the floating diffusion node FD. The charge transfer may cause the voltage of the floating diffusion node FD to drop from the supply voltage VDD to a second voltage that is indicative of the image data (e.g., photogenerated electrons accumulated on the photosensitive element PE during the exposure period). The floating diffusion node FD is coupled to control a gate terminal of the AMP transistor T3. This second voltage may bias the AMP transistor T3. AMP transistor T3 operates as a source-follower transistor providing a high impedance connection to the floating diffusion FD.

The AMP transistor T3 is coupled between the voltage supply VDD and the row select transistor T4. The AMP transistor T3 has a gate terminal coupled to the floating circuit node FD and a channel terminal coupled to the column readout line or bit line. The AMP transistor T3 is coupled to the readout column line when the row select signal RS is asserted on the row select transistor T4. The row select transistor T4 selectively couples the output of the pixel to the readout column line when the row select signal RS is applied to the row select transistor T4.

For purposes of illustration, a particular example of circuitry for 4T pixels has been shown and described. Different 4T pixels are also suitable, as well as pixels having transfer gates and either fewer or more than four pixels, including pixels in which one or more transistors are shared by two or more pixels. Furthermore, in one or more embodiments, one or more of a reset transistor, a source-follower transistor, and a row select transistor, may be shared by two or more pixels.

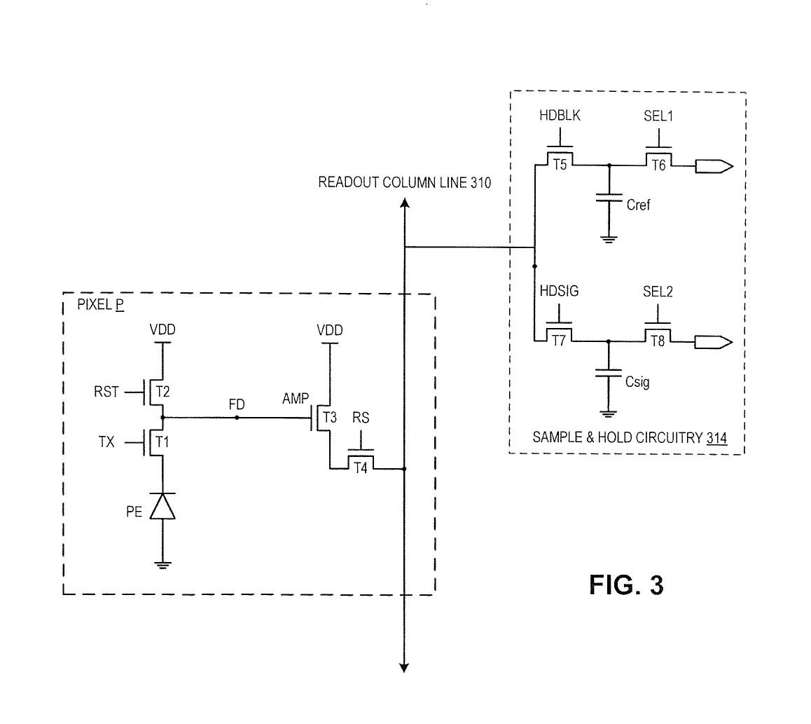

FIG. 3 is a circuit diagram illustrating an example embodiment of a pixel P and an example embodiment of sample and hold circuitry 314 for a pixel array or image sensor. In one embodiment, the pixel P and the sample and hold circuitry 314 may be implemented in the image sensor system of FIG. 1, or one similar. Alternatively, the pixel P and the sample and hold circuitry 314 may be implemented in an entirely different image sensor system.

The illustrated pixel P is similar to the pixels Pa and Pb of FIG. 2, and will not be discussed further in detail. As before, other pixel circuitries (e.g., having other numbers of transistors) are also suitable for the pixel P. The pixel P is coupled with a readout column line 310. Similarly, other pixels in a column of the pixel array may be coupled with the readout column line.

The sample and hold circuitry 314 is operable to sample and hold the image data captured by the pixels. Within each pixel, the row select transistor T4 is used select which row within the pixel array to transfer an image signal into the sample and hold circuitry 314 at a given time under control of the row select signal RS. The illustrated embodiment of sample and hold circuitry includes a first hold transistor T5, a reference capacitor Cref, a first select transistor T6, a second hold transistor T7, a signal capacitor Csig, and a second select transistor T8. In one embodiment, sample and hold circuitry is time shared by the pixels coupled to the column readout line.

A black level reference signal may be acquired from the pixel P. The black level reference signal may be used as an offset value to cancel out thermal noise or other circuit noise. The black level reference signal may be acquired by asserting a HDBLK signal to the first hold transistor T5 to sample the black level reference signal output from the pixel P on the column readout line with reference capacitor Cref. The sampled black level reference signal may subsequently be output from the sample and hold circuitry through the first select transistor T6 under control of a first select signal SEL1 applied thereto.

An image signal may also be acquired from the pixel. Similarly, the image signal may be acquired by asserting a HDSIG signal to the second hold transistor T7 to sample the image signal output from the pixel on the column readout line with signal capacitor Csig. The sampled image signal may subsequently be output from sample and hold circuitry through the second select transistor T8 under control of a second select signal SEL2 applied thereto.

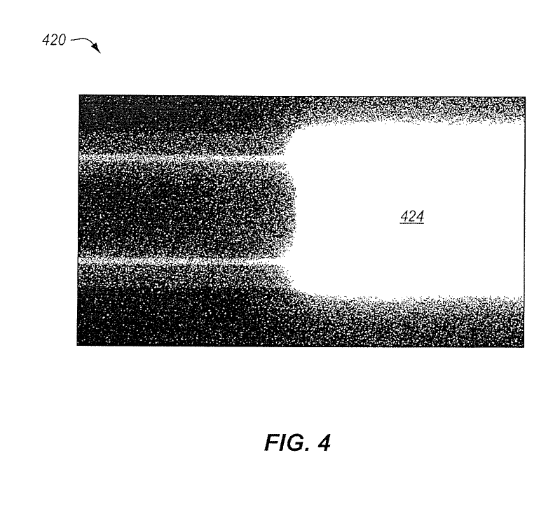

FIG. 4 conceptually illustrates an example of a horizontal or row banding artifact 422 in an image 420. The horizontal or row banding artifact may occur in cameras or other image acquisition devices under certain conditions or in certain environments, such as when acquiring an image that includes a bright window or other region against a dark background. To fiducially represent what was imaged, the image 420 should include a bright region or window 424 at right and center in the image, against what should be a dark background 426 everywhere else. However, in the actual image the horizontal or row banding artifact 422 is present at left and center in the image at rows corresponding to the extent of the bright region or window 424. The horizontal or row banding represents artificially bright regions at rows that include the bright window. Instead of being bright, the horizontal or row banding region 422 should be dark. The horizontal or row banding artifact tends to be more significant when very bright windows or regions are imaged against dark backgrounds and tends to be more significant in arrays with large numbers of pixels. Such horizontal or row banding is generally undesirable.

Without wishing to be bound by theory, it is presently believed that one factor that contributes to horizontal or row banding is unintended perturbation or alteration of transfer gate off-state voltage values that are provided to transfer gates. The perturbation or alteration of the transfer gate off-state voltages is due at least in part to parasitic capacitance. The parasitic capacitance involves typically unavoidable and generally unwanted capacitance that exists between closely spaced conductors separated by non-conducting or insulating materials as a result of their proximity to one another.

The off-state voltages are typically provided to the transfer gates using a single line or wire. This single line or wire will be referred to as a single transfer gate off voltage supply line or wire. During image signal readout, the voltages on the readout column lines or bit lines may change due to the image data. The change or swing in the voltage on the readout column lines may be greater for rows of the image having bright windows or bright regions. The readout column lines may capacitively couple with the transfer gates of each of the pixels due to their proximity. During the sample/hold phase of the image signal readout, the transfer gates of all of the pixels may couple with the single transfer gate off voltage supply line (i.e., the off-state voltage is applied or coupled to the transfer gates). As a result, the readout column lines may also capacitively couple with the transfer gate off voltage supply line at all of the pixels during the image signal readout. By way of example, in the case of a 12 megapixel (MP) image sensor having 12 million pixels, if the coupling capacitance at each pixel is 0.1 femto Farad (fF), for example, then the total coupling capacitance between the readout column lines and the transfer gate off voltage supply line may be 1.2 nano Farad (nF). If the voltage swing on the readout column lines is 1 volt (V), then there will be about 1.2 nF times 1V of charge coupled to the single transfer gate off state voltage supply line. The larger the voltage swing on the readout column lines, typically the greater the amount of charge coupled.

The voltage supplied on the transfer gate off voltage supply line may be perturbed or altered (e.g., there may be a small voltage change on the single transfer gate voltage supply line), and it may take a significant amount of time (e.g., on the order of several microseconds) for the voltage to settle/stabilize back to its original value. Moreover, the transfer gate off voltage supply line may also couple with the floating diffusion nodes FD for the selected row of pixels through the transfer gates. In contrast, during acquisition of a black level reference signal (i.e., when no or little light is used to deliberately expose the pixel array) there may be no, or at least significantly less, voltage swing on the readout column lines, since the pixels have accumulated less charge (e.g., typically no light is incident on the pixel array). As a result, the amount of capacitive coupling between the readout column lines and the transfer gate off voltage supply line may be much less. Consequently, the transfer gate off voltage on the transfer gate off voltage supply line may not be perturbed, or at least may be significantly less perturbed (i.e., much less change in voltage if any at all). As a result, the transfer gate off voltage value on the single transfer gate off voltage supply line may change during image signal readout, but may not change (or at least change less) during black level reference signal readout. The transfer gate off voltage on the transfer gate off voltage supply line may also couple with the floating diffusion nodes for the selected row of pixels through the transfer gates. When the transfer gate off voltages on the single transfer gate off voltage supply line are different during image signal readout and black level reference signal readout, this may cause, result in, or at least contribute to row banding.

In brief, different row transfer gate off voltage may have different voltage change during readout timing due to parasitic coupling by different image signal intensity. If the transfer gate off voltage cannot completely stabilize or settle back, the difference may cause image artifacts in the image which appear especially at very high gain. As will be explained further below, using the two transfer gate off voltage supply lines as disclosed herein may help to significantly reduce the change in the voltage on the transfer gate supply line, and correspondingly help to reduce the extent of image artifacts.

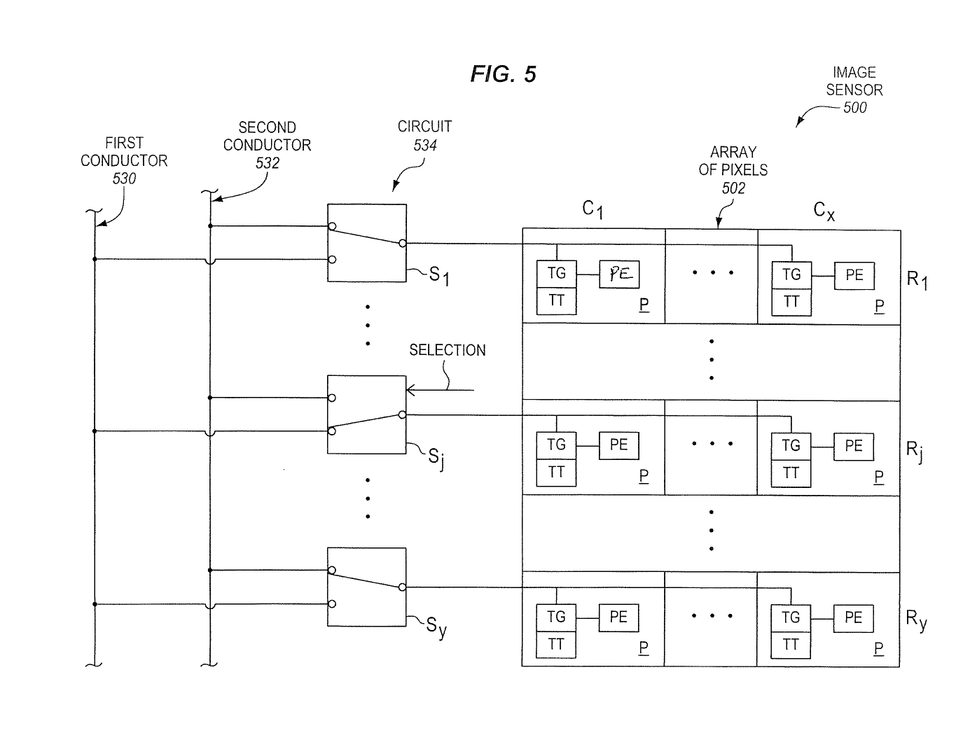

FIG. 5 is a block diagram of an embodiment of an image sensor 500 having a first transfer gate off voltage supply conductor 530 and a second transfer gate off voltage supply conductor 532. In one or more embodiments, the image sensor 500 and transfer gate off voltage supply conductors 530, 532 may be included in the image sensor of FIG. 1, or one similar, or an entirely different image sensor. In one or more embodiments, the image sensor 500 may be a CMOS image sensor.

The image sensor includes an array of pixels 502. The array of pixels is a two-dimensional array of pixels where pixels P are arranged into rows (e.g., rows R1 through Ry) and columns (e.g., column Cl through Cx). Commonly there are a large number of rows and columns (e.g., without limitation there may be from 1 to 20 megapixels, or more, where a megapixel is a million pixels). In one or more embodiments, the pixels may be similar to the pixels Pa and Pb of FIG. 2. Alternatively, entirely different pixels may optionally be used, such as pixels having transfer gates and four transistors, more than four transistors, or less than four transistors, including pixels in which one or more transistors are shared by two or more pixels.

Each of the pixels includes a photosensitive element PE to provide an array of photosensitive elements PEs. In one embodiment, the photosensitive elements PE are photodiodes. Alternatively, other examples of photosensitive elements include, but are not limited to, charge-coupled devices (CCDs), quantum device optical detectors, photogates, phototransistors, and photoconductors. Photosensitive elements used in complementary metal oxide semiconductor (CMOS) active-pixel sensors (APS) are believed to be especially suitable.

Each of the pixels includes a transfer transistor TT to provide an array of transfer transistors TTs. Each of the transfer transistors has a transfer gate TG. The transfer transistors may represent controllable switches. The transfer transistors or switches may either be in an “on” state or in an “off” state. The transfer transistors or switches may be controlled to be either in the “on” state or the “off' state based on voltages or other electrical or control signals applied to the transfer gates. For example, a transfer gate “on” voltage may be applied to a transfer gate to cause the transfer transistor to be “on” to cause a charge to be transferred from the photosensitive element PE to a floating diffusion node, or a transfer gate “off' voltage may be applied to the transfer gate to cause the transfer transistor to be “off' to disconnect the photosensitive element PE from the floating diffusion node.

Referring again to FIG. 5, the image sensor also includes the first transfer gate off voltage supply conductor 530 and the second transfer gate off voltage supply conductor 532. The first and second transfer gate off voltage supply conductors may each include one or more metals or other conductive materials in the form of one or more lines, wires, rails, interconnects, paths, other voltage supply structures, or combinations thereof. The first and second transfer gate off voltage supply conductors may either be entirely separate conductors, or else the first and second transfer gate off voltage supply conductors may share a common segment of conductor (e.g., they may be branches or forks originating at a common or shared line, wire, or other conductor). Each of the first and second transfer gate off voltage supply conductors may conduct or otherwise supply a transfer gate off state voltage. The transfer gate off state voltage may be a voltage corresponding to a transfer transistor or transfer gate off state and/or may be a voltage operable to cause or result in a transfer transistor or transfer gate off state.

The image sensor also includes a circuit 534. The circuit is coupled with the first and second transfer gate off voltage supply conductors 530, 532. The circuit is operable to couple the first transfer gate off voltage supply conductor 530 to transfer gates TGs of a first subset of the pixels of the array. The circuit is also operable to concurrently couple the second transfer gate off voltage supply conductor 532 to transfer gates TGs of a second subset of the pixels of the array.

As shown, in one embodiment, the circuit may include a plurality of switches S1, Sj, Sy. Various different types of circuitry suitable for implementing switches is suitable. Each of the switches may be coupled with both the first and second transfer gate off voltage supply conductors 530, 532. Each of the switches is also coupled with the transfer gates of a different group or subset of pixels of the array. In the illustrated example embodiment, one switch is provided per row of pixels. A first switch 51 is coupled with the transfer gates TGs of a first row R1 of pixels, a j-th switch Sj is coupled with the transfer gates TGs of a row Rj of pixels, and a y-th switch Sy is coupled with the transfer gates TGs of a row Ry of pixels. Each of the switches is operable to switchably couple the transfer gates of the corresponding row of pixels with either the first transfer gate off voltage supply conductor 530 or the second transfer gate off voltage supply conductor 532. In alternate embodiments, the switches may be coupled with other groups of pixels (e.g., two or more rows of pixels).

In the illustrated example embodiment, a single row, which in this example is the row Rj, is currently selected for readout. In one embodiment, a row counter circuit or a controller unit (not shown) may select the row Rj for readout at an appropriate time by generating a row address for readout. The transfer gates of the selected row Rj are coupled with the first transfer gate off voltage supply conductor 530, whereas in the illustrated embodiment the transfer gates of all of all of the other rows of pixels are coupled with the second transfer gate off voltage supply conductor 532. The switch Sj switchably couples the first transfer gate off voltage supplied by the first transfer gate off voltage supply conductor 530 to the transfer gates of the row Rj of pixels. In one embodiment, the transfer gates of the row Rj are coupled with the first transfer gate off voltage supply conductor 530 during the readout process for the row Rj whenever the transfer gate on voltage is not applied and/or whenever charge is not transferred from a photodiode to a floating diffusion node within the row Rj. The switch S1 concurrently switchably couples the second transfer gate off voltage supplied by the second transfer gate off voltage supply conductor 532 to the transfer gates of the row R1 of pixels. Similarly, the switch Sy concurrently switchably couples the second transfer gate off voltage supplied by the second transfer gate off voltage supply conductor 532 to the transfer gates of the row Ry of pixels.

The illustrated example embodiment shows a single row selected for readout, although the scope of the invention is not so limited. In one or more alternate embodiments, two, three, or more rows may be selected for concurrent readout. Concurrent readout helps to read out a larger number of pixels within a given amount of time, and tends to be useful for image sensors with large numbers of pixels. In one embodiment, the plurality of rows selected for readout may be coupled with the first transfer gate off voltage supply conductor 530, whereas other rows of the array may be coupled with the second transfer gate off voltage supply conductor 532.

Still further, it is not required to couple only the rows selected for readout with the first transfer gate off voltage supply conductor 530. In one embodiment, one or more other rows not-selected for readout may optionally be coupled with the first transfer gate off voltage supply conductor 530, along with one or more rows selected for readout. In one embodiment, a subset of rows (which typically is less than half of the rows in order to achieve desirable reductions in row banding) including the one or more rows selected for readout, may be coupled with the first transfer gate off voltage supply conductor 530, whereas another subset of rows (e.g., all remaining rows) may be coupled with the second transfer gate off voltage supply conductor 532.

Embodiments using rows for readout, and embodiments describing coupling rows to the first or second transfer gate off voltage supply conductors have been described, although the scope of the invention is not so limited. Using rows for readout is prevalent, but not required. Rather than selecting rows for readout, in various other embodiments, a portion of a row may be selected for readout, one or more individual pixels may be selected for readout, one or more columns may be selected for readout, one or more chunks or other groups of pixels in one or more rows may be selected for readout, etc. In such embodiments, a subset of pixels including the selected pixels may be coupled with the first transfer gate off voltage supply conductor 530, whereas another subset of pixels not including the selected pixels may be coupled with the second transfer gate off voltage supply conductor 532. In addition, rather than only two transfer gate off voltage supply conductors, there may be three or more transfer gate off voltage supply conductors.

Advantageously, using both the first and second transfer gate off voltage supply conductors 530, 532, instead of a single conductor, may help to reduce row banding. As previously mentioned, without wishing to be bound by theory, it is presently believed that one factor that contributes to banding is undesirable perturbation or alteration of transfer gate off-state voltages that are provided to transfer gates due at least in part to parasitic capacitance. When the first and second transfer gate off voltage supply conductors 530, 532 are provided, the amount of charge coupled to the first transfer gate off voltage supply conductor 530 by the subset of pixels including those pixels selected for readout will be significantly less, and the perturbation or alteration of the first transfer gate off voltage will also be significantly less. By way of example, in the case of a 12 megapixel image sensor having 12 million pixels, divided into 3 million rows and 4 million columns, if the coupling capacitance at each pixel is 0.1 fF, for example, and only one row is coupled to the first transfer gate off voltage supply conductor, then the total coupling capacitance to the first transfer gate off voltage supply conductor may be only about 0.4 pico Farads (pF). If the bit line swing is 1V, there will be only 0.4 pF times 1V of charge coupled to the first transfer gate off voltage supply conductor. The 0.4 pF times 1V of charge is only a fraction of the 1.2 nF times 1V of charge described above, and typically will not perturb or alter the first transfer gate off voltage. This may help to reduce banding image artifacts.

In one or more embodiments, substantially the same transfer gate off voltage values may be provided on the first and second transfer gate off voltage supply conductors. As used herein, the transfer gate off voltage values or voltages are substantially the same when they are within 0.1V of one another. Alternatively, in one or more embodiments, substantially different transfer gate off voltage values may be provided on the first and second transfer gate off voltage supply conductors. As used herein, the transfer gate off voltage values or voltages are substantially different when they differ from one another by more than 0.1V.

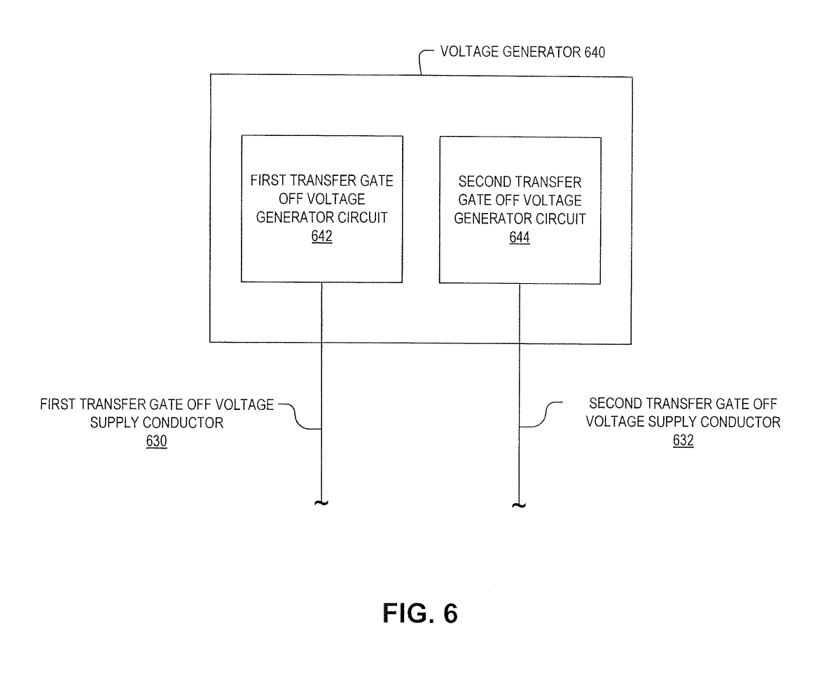

FIG. 6 is a block diagram of a voltage generator 640 that is operable to generate different transfer gate off voltages for first and second transfer gate off voltage supply conductors 630, 632. In one embodiment, the voltage generator 640 and the first and second transfer gate off voltage supply conductors 630, 632 may be included in the image sensor 500 of FIG. 5, or one similar, or an entirely different image sensor.

The voltage generator includes a first transfer gate off voltage generator circuit or portion 642 to generate and provide a first transfer gate off voltage on the first transfer gate off voltage supply conductor 630 coupled thereto. The voltage generator also includes a second transfer gate off voltage generator circuit or portion 644 to generate and provide a second, different transfer gate off voltage on the second transfer gate off voltage supply conductor 632 coupled thereto.

Some images may exhibit image lag in which the entire image signal is not completely read during a given readout, but rather some residual signal remains which may be read in one or more subsequent readouts. For example, small pixels with high full well capacity (FWC) may experience some image lag. Full well capacity represents the amount of charge or electrons that can be collected and transferred by each pixel.

In one or more embodiments, the substantially different transfer gate off voltages may be used to help reduce image lag. The first transfer gate off voltage may be provided on the first transfer gate off voltage supply conductor 630 to a first subset of pixels including pixels selected for readout, whereas the second transfer gate off voltage may be provided on the second transfer gate off voltage supply conductor 632 to a second subset of pixels not selected for readout. To help reduce image lag, the first transfer gate off voltage may have a greater voltage difference from a transfer gate “on” voltage (e.g., a TX signal) than the second transfer gate off voltage.

For example, in one embodiment, the transfer transistor may be an n-type metal oxide semiconductor (NMOS) field effect transistor (FET). For the n-type FET, the first transfer gate off voltage generated by the first circuit 642 may have a voltage in a range of from about −1.5V to about −2.5V, and the second transfer gate off voltage generated by the second circuit 644 may have a less negative voltage in a range of from about −0.5V to about −1.5V. In some cases, the first transfer gate off voltage may be in a range of from about −1.8V to about −2.2V, and the second transfer gate off voltage may have a less negative voltage in a range of from about −0.8V to about −1.2V. Analogous different positive voltages are suitable for p-type FET transfer transistors.

Using the first transfer gate off voltage having a greater voltage difference from a transfer gate “on” voltage than the second transfer gate off voltage (for example a more negative first transfer gate off voltage in the case of an NMOS transfer transistor), may help to increase the voltage on the floating diffusion node (FD). The greater the voltage difference between the transfer gate “on” and “off' voltages, the greater the voltage swing or change on the transfer gate when the transfer gate is turned on to transfer the image charge to the floating diffusion node. Since the transfer gate has a certain amount of coupling capacitance to the floating diffusion node, such a greater voltage swing or change may tend to help increase the after transfer voltage on the floating diffusion node. This may help to reduce image lag. Another advantage to the use of negative voltages is that they may help to reduce dark current.

Conventionally, the use of such relatively negative transfer gate off voltages, for example in the range of from about −1.5V to about −2.5V, on a single transfer gate off voltage supply line would tend to have drawbacks, such as an increase in white pixels and/or a reduction in device reliability. Such relatively negative transfer gate off voltages would tend to create higher electric fields across the transfer gate leading to more white pixels and would tend to produce higher voltage drops across the transfer gate leading to reduced device reliability. However, by including the two transfer gate off voltage supply conductors, and by using the relatively negative transfer gate off voltages for only a portion or in some cases only a small fraction of the total readout time for the entire array, such drawbacks may be significantly reduced while still observing the reduction in image lag. By way of example, in one embodiment, each row may be subjected to these relatively negative transfer gate off voltages only while that row is being readout, while at other times the row may be subjected to the less negative transfer gate off voltages (for example a voltage from about −0.5V to about −1.5V). As a result, image lag may be reduced without significantly causing white pixel or decreased device reliability.

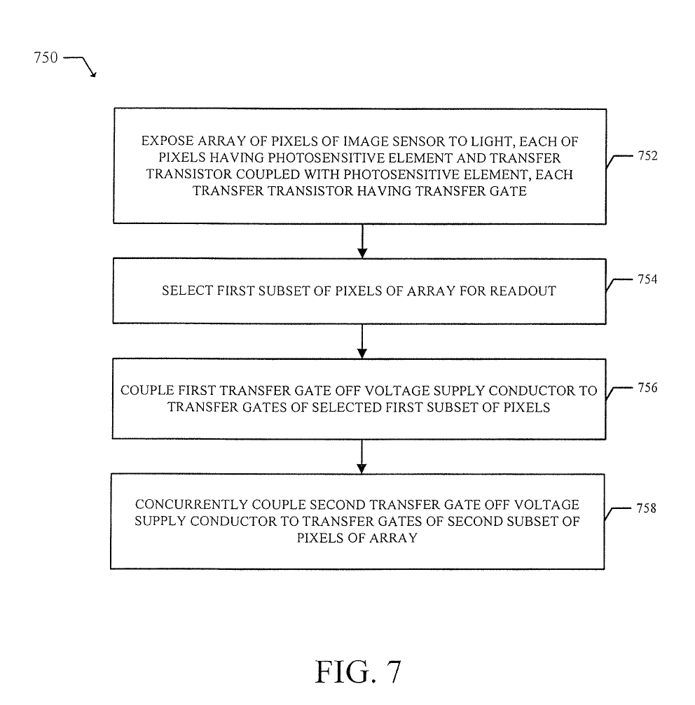

FIG. 7 is a block flow diagram of an embodiment of a method 750 of coupling first and second transfer gate off voltage supply conductors with transfer gates of first and second subsets of pixels of a pixel array. In one or more embodiments, the method may be performed by and/or within the image sensor 500 of FIG. 5, or one similar. Alternatively, the method 750 may be performed by and/or within an image sensor or electronic device having an image sensor entirely different than that of FIG. 5.

The method includes exposing an array of pixels of an image sensor to light, at block 752. Each of the pixels may have a photosensitive element and a transfer transistor coupled with the photosensitive element. Each transfer transistor may have a transfer gate.

A first subset of the pixels of the array may be selected for readout, at block 754. In one embodiment, the first subset of the pixels may be one or more rows of pixels selected for readout. In one embodiment, a row counter circuit or a controller unit may select the one or more rows of pixels for readout by generating one or more row addresses for readout.

A first transfer gate off voltage supply conductor may be coupled with the transfer gates of the selected first subset of the pixels, at block 756. In one embodiment, one or more switches corresponding to the one or more rows of pixels selected for readout may be controlled to couple the one or more selected rows with the first transfer gate off voltage supply conductor. In some embodiments, one or more rows of pixels besides just the row(s) selected for readout may optionally also be coupled with the first transfer gate off voltage supply conductor.

Concurrently, a second transfer gate off voltage supply conductor may be coupled with the transfer gates of a second different subset of the pixels of the array, at block 758. In one embodiment, switches corresponding to all of the other rows of the pixel array besides those coupled with the first transfer gate off voltage supply conductor may be controlled to couple the transfer gates within their corresponding rows with the second transfer gate off voltage supply conductor.

In one or more embodiments, the voltages from the first and second transfer gate off voltage supply conductors may be substantially the same. Alternatively, in one or more embodiments, the voltages from the first and second transfer gate off voltage supply conductors may be substantially different.

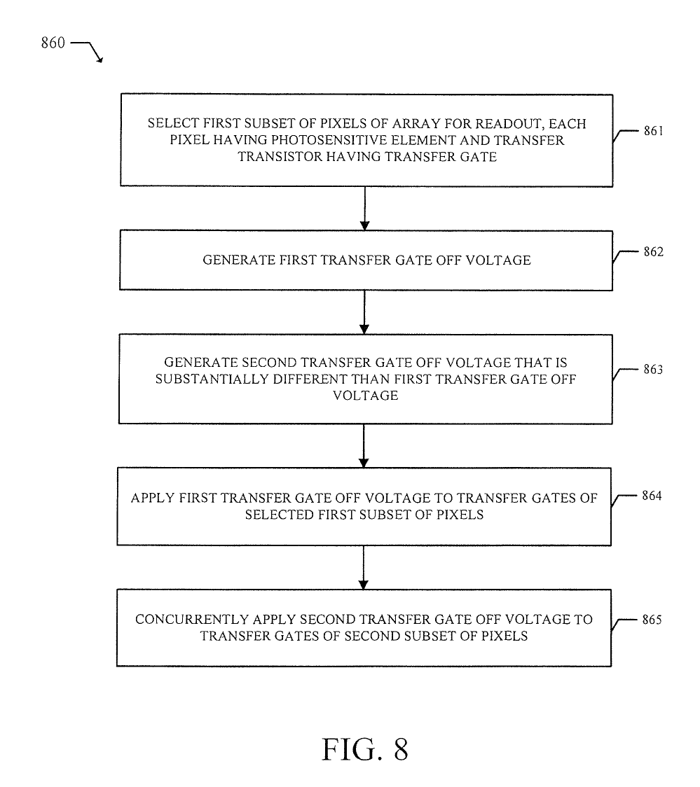

FIG. 8 is a block flow diagram of an embodiment of a method 860 of applying first and second transfer gate off voltages to transfer gates of first and second subsets of pixels of a pixel array. In one or more embodiments, the method may be performed by and/or within the image sensor 500 of FIG. 5, or one similar. Alternatively, the method 750 may be performed by and/or within an image sensor or electronic device having an image sensor entirely different than that of FIG. 5.

A first subset of pixels of an array of pixels may be selected for readout, at block 861. Each of the pixels of the array may have a photosensitive element and a transfer transistor coupled with the photosensitive element. Each of the transfer transistors may have a transfer gate,

A first transfer gate off voltage may be generated at block 862 and a second transfer gate off voltage may be generated at block 863. In one embodiment, the first and second transfer gate off voltages may be substantially different. In one embodiment, the first transfer gate off voltage may have a greater voltage difference from a transfer gate on voltage than the second transfer gate off voltage. For example, for n-type FET, the first transfer gate off voltage may range from about −1.5V to about −2.5V, and the second transfer gate off voltage may be a less negative voltage ranging from about −0.5V to about −1.5V. In some cases, the first transfer gate off voltage may range from about −1.8V to about −2.2V, and the second transfer gate off voltage may range from about −0.8V to about −1.2V. These voltages may be generated by the voltage generator 640 of FIG. 6, or an entirely different voltage generator.

The first transfer gate off voltage may be applied to transfer gates of the selected first subset of the pixels, at block 864. Concurrently, the second transfer gate off voltage may be applied to transfer gates of a second subset of the pixels, at block 865. The substantially different transfer gate off voltages may help to reduce image lag without significantly adversely causing white pixels or reducing device reliability.

In the description above and the claims below, the terms “coupled” and “connected,” along with their derivatives, are used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. For example, a circuit may be coupled with a transfer gate off voltage supply conductor through one or more intervening components.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It will also be appreciated, by one skilled in the art, that modifications may be made to the embodiments disclosed herein, such as, for example, to the configurations, magnitudes, functions, and manner of operation, of the components of the embodiments. All equivalent relationships to those illustrated in the drawings and described in the specification are encompassed within embodiments of the invention.

Various operations and methods have been described. Some of the methods have been described in a basic form in the flow diagrams, but operations may optionally be added to and/or removed from the methods. In addition, while the flow diagrams show a particular order of the operations according to example embodiments, it is to be understood that that particular order is exemplary. Alternate embodiments may optionally perform the operations in different order, combine certain operations, overlap certain operations, etc.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. An apparatus comprising:
an array of pixels, each of the pixels of the array including:
a photosensitive element; and
a transfer transistor coupled with the photosensitive element, the transfer transistor having a transfer gate;
a first transfer gate off voltage supply conductor;
a second transfer gate off voltage supply conductor; and
a circuit coupled with the first and second transfer gate off voltage supply conductors, the circuit operable to couple the first transfer gate off voltage supply conductor to transfer gates of a first subset of the pixels of the array and to concurrently couple the second transfer gate off voltage supply conductor to transfer gates of a second subset of the pixels of the array.

2. The apparatus of claim 1, wherein the first transfer gate off voltage supply conductor is operable to supply a first transfer gate off voltage, wherein the second transfer gate off voltage supply conductor is operable to supply a second transfer gate off voltage, and wherein the first and second transfer gate off voltages are substantially different.

3. The apparatus of claim 2, wherein the first subset of the pixels of the array comprises pixels selected for readout, wherein the second subset of the pixels of the array comprises pixels not selected for readout, and wherein the first transfer gate off voltage has a greater voltage difference from a transfer gate on voltage than the second transfer gate off voltage.

4. The apparatus of claim 3, wherein the transfer transistors comprise N-type field effect transistors, wherein the first transfer gate off voltage has a voltage in a range of from −1.5V to −2.5V, and wherein the second transfer gate off voltage has a voltage in a range of from −0.5V to −1.5V.

5. The apparatus of claim 4, wherein the first transfer gate off voltage is in a range of from −1.8V to −2.2V, and wherein the second transfer gate off voltage has a voltage in a range of from −0.8V to −1.2V.

6. The apparatus of claim 1, wherein the first transfer gate off voltage supply conductor is operable to supply a first transfer gate off voltage, wherein the second transfer gate off voltage supply conductor is operable to supply a second transfer gate off voltage, and wherein the first and second transfer gate off voltages have substantially a same voltage value.

7. The apparatus of claim 1, wherein the first subset of the pixels is pixels selected for readout, and wherein the second subset of the pixels is pixels that are not selected for readout.

8. The apparatus of claim 7, wherein the first subset of the pixels selected for readout comprises one or more rows of pixels.

9. The apparatus of claim 1, wherein the circuit comprises:
a first set of one or more switches coupled with the first and second transfer gate off voltage supply conductors and each coupled with the transfer gates of pixels in a different row of pixels in the first subset of the pixels; and
a second set of one or more switches coupled with the first and second transfer gate off voltage supply conductors and each coupled with the transfer gates of pixels in a different row of pixels in the second subset of the pixels.

10. The apparatus of claim 1, wherein the pixel array comprises at least 12 megapixels.

11. The apparatus of claim 1, wherein the apparatus comprises a complementary metal oxide semiconductor (CMOS) image sensor.

12. The apparatus of claim 1, wherein the first and second transfer gate off voltage supply conductors each comprise one or more selected from lines, wires, rails, interconnects, and conductive paths.

13. The apparatus of claim 1, further comprising:
one or more lenses optically coupled to focus light on the array of pixels;
a shutter optically coupled to allow light to pass through the one or more lenses;
a processor to process image data; and
a memory to store image data.

14. An apparatus comprising:
an image sensor, the image sensor including an array of photosensitive elements, each of the photosensitive elements coupled with a corresponding transfer transistor, each of the transfer transistors having a transfer gate;
a first transfer gate off voltage supply line to supply a first transfer gate off voltage;
a second transfer gate off voltage supply line to supply a second transfer gate off voltage; and
a first switch coupled with the first and second transfer gate off voltage supply lines and coupled with a first subset of the transfer gates, the first switch to switchably couple the first transfer gate off voltage to the first subset of the transfer gates;
a second switch coupled with the first and second transfer gate off voltage supply lines and coupled with a second subset of the transfer gates, the second switch to switchably couple the second transfer gate off voltage to the second subset of the transfer gates.

15. The apparatus of claim 14, wherein the first and second transfer gate off voltages are substantially different.

16. The apparatus of claim 15, wherein the first subset of the transfer gates comprise transfer gates for pixels selected for readout, wherein the second subset of the transfer gates comprise pixels not selected for readout, and wherein the first transfer gate off voltage has a greater voltage difference from a transfer gate on voltage than the second transfer gate off voltage.

17. The apparatus of claim 14, wherein the first subset of the transfer gates is transfer gates for pixels selected for readout, and wherein the second subset of the transfer gates is transfer gates for pixels not selected for readout.

18. An image sensor comprising:
an array of pixels, each of the pixels of the array including:
a photosensitive element; and
a transfer transistor coupled with the photosensitive element, the transfer transistor having a transfer gate;
a first voltage generator circuit, the first voltage generator circuit to generate a first transfer gate off voltage; and
a first transfer gate off voltage supply conductor coupled with the first voltage generator circuit, the first transfer gate off voltage supply conductor to receive and supply the first transfer gate off voltage;
a second voltage generator circuit, the second voltage generator circuit to generate a second transfer gate off voltage, which is different than the first transfer gate off voltage;
a second transfer gate off voltage supply conductor coupled with the second voltage generator circuit, the second transfer gate off voltage supply conductor to receive and supply the second transfer gate off voltage; and
a circuit including a plurality of switches each coupled with the first and second transfer gate off voltage supply conductors, the plurality of switches including:
a first switch operable to switchably couple the first transfer gate off voltage to transfer gates of a first row of the pixels that are selected for readout; and
a second switch operable to concurrently switchably couple the second transfer gate off voltage to transfer gates of a second row of the pixels that are not selected for readout,
wherein the first transfer gate off voltage has a greater voltage difference from a transfer gate on voltage than the second transfer gate off voltage.

19. A method comprising:
exposing an array of pixels of an image sensor to light, each of the pixels having a photosensitive element and a transfer transistor coupled with the photosensitive element, each transfer transistor having a transfer gate;
selecting a first subset of the pixels of the array for readout;
coupling a first transfer gate off voltage supply conductor to transfer gates of the selected first subset of the pixels; and
concurrently coupling a second transfer gate off voltage supply conductor to transfer gates of a second subset of the pixels of the array.

20. The method of claim 19, further comprising:
providing a first transfer gate off voltage from the first transfer gate off voltage supply conductor to the first subset of the pixels; and
providing a second transfer gate off voltage from the second transfer gate off voltage supply conductor to the second subset of the pixels, wherein the first and second transfer gate off voltages are substantially different.

21. The method of claim 19, wherein the first subset of the pixels comprise pixels selected for readout, wherein the second subset of the pixels comprise pixels not selected for readout, and wherein the first transfer gate off voltage has a greater voltage difference from a transfer gate on voltage than the second transfer gate off voltage.

22. The method of claim 19, wherein the first subset of the pixels comprises pixels selected for readout, and wherein the second subset of the pixels comprises pixels that are not selected for readout.
